(19) United States
(12) Patent Application Publication
(10) Pub. No.: US 2007/0218846 A1
(43) Pub. Date: Sep. 20, 2007

(54) Radio comprising multiple transceivers

(76) Inventors: Timothy Neill, Houston, TX (US); Robin T. Castell, Houston, TX (US); Dean G. Dutterer, Houston, TX (US); Harold S. Merkel, Houston, TX (US); Isaac Lagnado, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/376,429

(22) Filed: Mar. 15, 2006

(51) Int. Cl. H04B 1/38

(52) U.S. Cl. 455/90.1; 455/101

(57) ABSTRACT

A radio comprises a first transceiver, a second transceiver, and a baseband control coupled to the first and second transceivers. The baseband control selectively implements one of at least a first and a second communication mode. For the first communication mode, the first transceiver transmits and receives data while the second transceiver functions as a diversity receive transceiver. For the second communication mode, the second transceiver transmits and receives data and does not function as a diversity receive transceiver.

### BACKGROUND

Communication devices, such as cellular telephones, are used in most countries of the world. Different communication protocols are used in different geographical locations. Generally, a communication device designed to work in accordance with one protocol will not work in a geographical area in which a different communication protocol is used. Different communication protocols, unfortunately, make difficult the implementation of a single communication device that can function in accordance with such different protocols.

### BRIEF DESCRIPTION OF THE DRAWINGS

For a detailed description of exemplary embodiments of the invention, reference will now be made to the accompanying drawings in which:

FIG. 1 shows a block diagram of a wireless device in accordance with embodiments of the invention;

FIG. 2 illustrates various communication protocols which can be used to advantage by embodiments of the invention;

FIG. 3 further illustrates various communication protocols which can be used to advantage by embodiments of the invention; and

FIG. 4 shows a block diagram of a wireless device in accordance with other embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

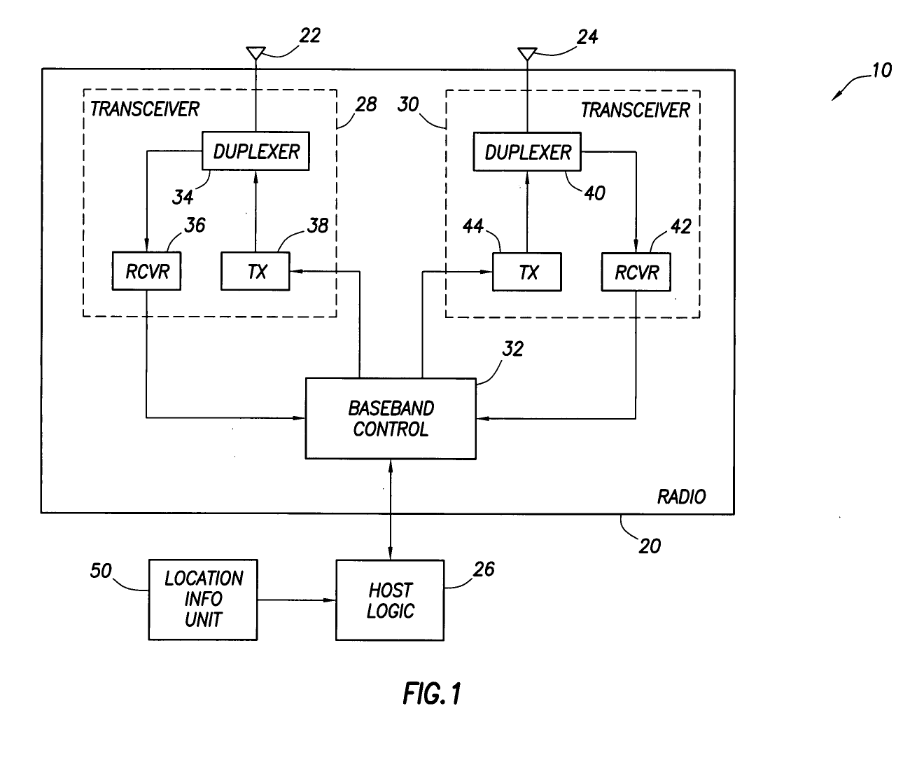

FIG. 1 shows an apparatus 10 that provides any of multiple functions. At least one such function is the ability to wirelessly communicate with other devices. As such, the apparatus 10 is referred to as a “communication device.” In accordance with at least some embodiments, the communication device 10 comprises a computer (e.g., a portable computer). As shown, the communication device comprises a radio 20 coupled to antennas 22, 24, and to a host logic 26. The communication device 10 also comprises a location information unit 50 coupled to, or provided as part of, the host logic 26. In embodiments in which the communication device 10 comprises a computer, the host logic 26 comprises at least a processor and memory. The radio 20 and antennas 22, 24 provide the communication device 10 with the ability to wirelessly communicate with other devices such as other communication devices. To transmit data, the host logic 26 provides the data to the radio 20 to be transmitted via an antenna 22 and/or 24. Wireless communications received via antennas 22 and/or 24 are provided through the radio 20 to the host logic 26 for further processing.

The radio 20 of FIG. 1 comprises first and second transceivers 28 and 30, and a baseband control 32 coupled to the transceivers. The baseband control 32 and/or host logic 26 comprise a control unit that performs some, or all, of the actions described herein. For the communication device 10 to transmit data, the baseband control 32 receives data to be transmitted from the host logic 26 and generates appropriate radio frequency (RF) signals to have the data transmitted by a transceiver 28, 30. Upon a transceiver receiving in-coming data via an antenna, the baseband control 32 translates the in-coming RF signals to a frequency range compatible with the host logic 26.

Each transceiver 28, 30 in the radio 20 comprises a duplexer, a receiver, and a transmitter. As such, transceiver 28 comprises duplexer 34, receiver 36, and transmitter 38, while transceiver 30 comprises duplexer 40, receiver 42, and transmitter 44. The receiver 36, 42 and transmitter 38, 44 of each transceiver 28, 30, respectively, couples to that transceiver's duplexer 34, 40. Each duplexer 34, 40 permits its associated antenna 22, 24 to be used to both transmit and receive data, thereby enabling both a receiver and a transmitter to use a common antenna for receiving and transmitting.

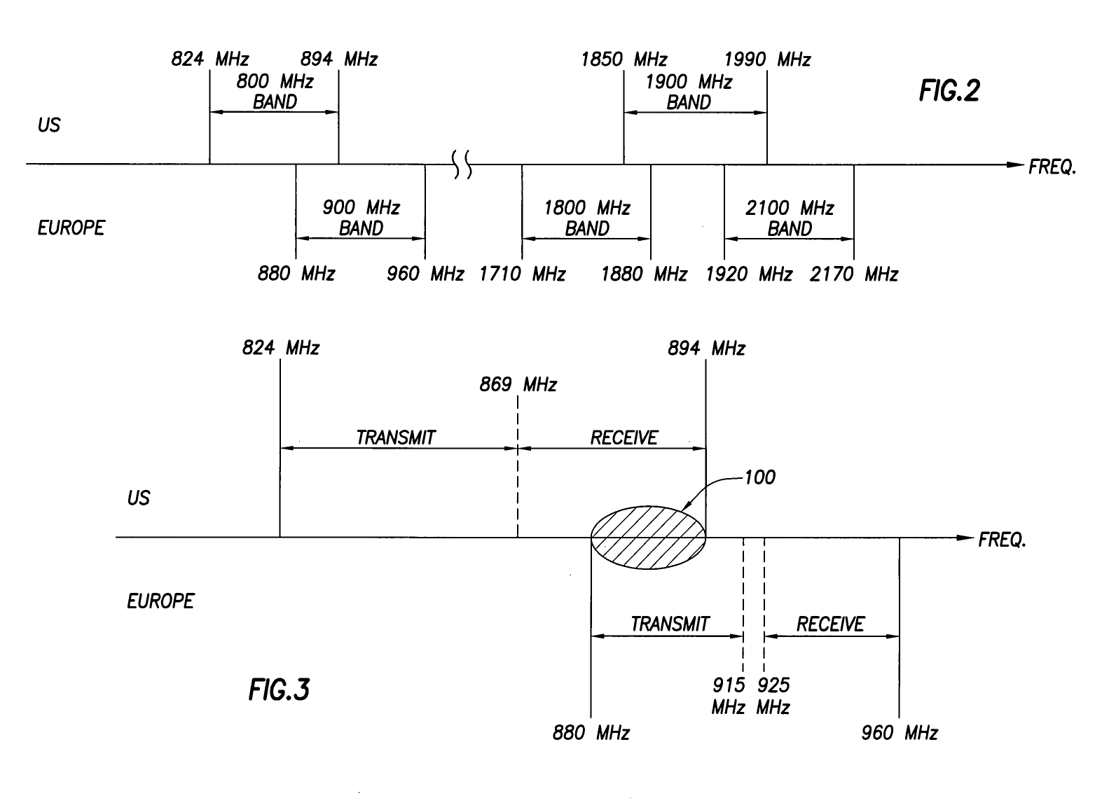

In various geographical regions (e.g., countries), wireless communication protocols are implemented to ensure proper communication between communication devices. The wireless communication protocol of one region may be different from the protocol of another region. For example, as depicted in FIG. 2 an applicable wireless protocol, which can be used to advantage by embodiments of the invention, in the United States (U.S.) comprises RF frequency bands of 824 to 894 MegaHertz (MHz) and 1850 to 1990 MHz. The lower frequency band is typically referred to as the 800 MHz band and the upper frequency band is typically referred to as the 1900 MHz band. In Europe, three frequency bands are implemented. One frequency band in Europe is from 880 to 960 MHz (referred to as the 900 MHz band). Another frequency band in Europe is from 1710 to 1880 MHz (referred to as the 1800 MHz band) and a third frequency band is from 1920 and 2170 MHz (referred to as the 2100 MHz band).

FIG. 3 shows an enlarged view of the lower frequency bands of the U.S. and European protocols, which can be used to advantage by embodiments of the invention. In the U.S., the 800 MHz band comprises a transmit portion and a receive portion. The transmit portion is from about 824 MHz to about 869 MHz and the receive portion is from about 869 MHz to about 894 MHz. The 900 MHz European band also comprises transmit and receive portions. The transmit portion is from about 880 MHz to about 915 MHz and the receive portion is from about 925 MHz to about 960 MHz. The 800 MHz U.S. band partially overlaps the 900 MHz European band. The overlap portion of the frequency bands is denoted by reference numeral 100.

The U.S. communication protocol permits diversity for receiving data. In an embodiment of a communication device that implements diversity, one transceiver functions as a “main” receive transceiver and another transceiver functions as a diversity receive transceiver. The signals received from the main and diversity transceivers are processed (e.g., added together) by, for example, the baseband control 32 to increase the signal-to-noise ratio. A diversity transceiver in the U.S. would thus be designed for the 869 MHz to 894 MHz receive portion of the 800 MHz frequency band. Diversity reception is not currently implemented in Europe. Instead, a single antenna is used to both receive and transmit.

Embodiments of the present invention take advantage of the partial frequency band overlap 100. A transceiver can be designed that functions sufficiently in at least a portion of the U.S. 800 MHz and in the European 900 MHz band. Any one or more of various parameters may be taken into account when designing or selecting such an antenna. Such parameters include, for example, return loss, gain pattern and antenna efficiency. More particularly, embodiments of the invention comprise a transceiver that functions as a diversity receive transceiver when the communication device 10 is located in the U.S., and as a non-diversity receive/transmit transceiver when the communication device 10 is located in Europe.

Referring again to FIG. 1, location information unit 50 provides location information to host logic 26. In an alternative embodiment, the location information unit 50 may be coupled to, or part of, the radio 20. The location information provided by the location information unit 50 is indicative of the location of the communication device 10. In some embodiments, the location information unit 50 comprises global positioning system (GPS) receiver. In other embodiments, the location information unit 50 comprises a user-input device that permits a user of the communication device to input the location (e.g., by country, by coordinates, etc.). Other embodiments of the communication device 10 do not include a location information unit 50 and determine location in accordance with other techniques. For example, the radio 20 will tune to predetermined frequency channels in each of the supported U.S. and European frequency bands to detect predetermined coded data. Such coded data contains various information about the associated cellular system and enables the communication device 10 to determine its geographical location.

The radio 20 configures itself (and in some embodiments, the control unit, or more specifically, the baseband control) for a communication mode selected from multiple communication modes in accordance with the location information provided or determined by the communication device 10. In a first communication mode, transceiver 28 transmits and receives data while the transceiver 30 functions as a diversity receive transceiver. In a second communication mode, transceiver 30 transmits and receives data and does not function as a diversity receive transceiver. Accordingly, if the location information indicates that the communication device is in a first location (e.g., the U.S.), the baseband control 32 causes the radio 20 to receive data via transceivers 28 and 30 with transceiver 30 providing diversity. If the location information, however, indicates a second location (e.g., Europe), the baseband control 32 causes the radio 20 to receive and transmit via transceiver 30 and not transceiver 28 (i.e., without diversity). In at least some embodiments, configuring multiple transceivers based on location can desirably result in a fairly small-sized radio solution.

The transmit portions of the U.S. 800 MHz and the European 900 MHz frequency bands do not overlap and thus, in the embodiment of FIG. 1, separate transmitters 38, 44 are used to transmit depending on the location of the communication device 10.

Table I illustrates the use of the transceivers 28 and 30 to implement the different communication protocols.

TABLE I
Transceiver Usage

| Protocol | Transceiver 28 functions as: | Transceiver 30 functions as |
|---|---|---|
| U.S. | Main for transmit and | Diversity for receive |
| | main for receive | |
| EUROPE | Not used | Main for transmit and |
| | | main for receive |

In other embodiments, the use of the transceivers 28 and 30 can be different from that shown in Table I. For example, transceiver 28 could be used as a receive diversity transceiver in the U.S. and as the main for transmit and receive in Europe, while transceiver 30 is used as the main for transmit and receive in the U.S. and unused in Europe. In yet other embodiments, one transceiver could function as the main transceiver for transmit and receive in two geographical regions, with the other transceiver being used as the receive diversity transceiver in one region.

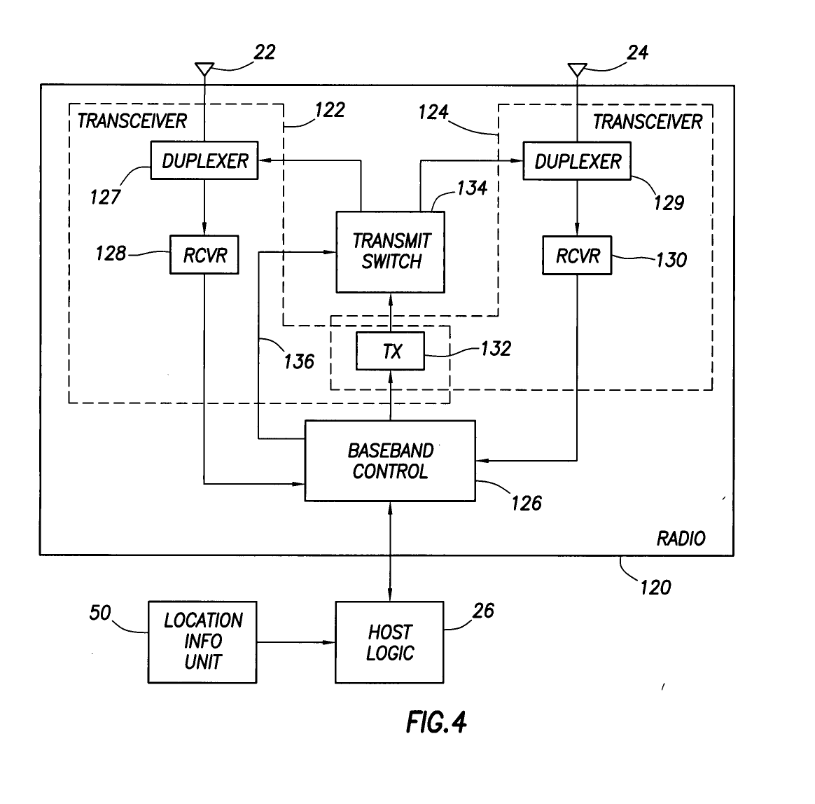

FIG. 4 illustrates another embodiment of a radio. The radio 120 shown in FIG. 4 comprises transceivers 122 and 124, baseband control 126 and a transmit switch 134. Each transceiver 122, 124 comprises a receiver and a duplexer. Transceiver 122 comprises a duplexer 127 and a receiver 128, and transceiver 124 comprises a duplexer 129 and a receiver 130. The radio 120 of FIG. 4 comprises a single transmitter 132 that is shared between both transceivers 122, 124. Because a single transmitter 132 is used, the transmit switch 134 selectively provides transmit signals to either transceiver's duplexer. The baseband control 126 asserts a control signal 136 to the transmit switch 134 to cause the transmit switch 134 to selectively provide transmit signals to either duplexer 127 or 129 depending on the communication protocol in the location of the communication device. The transmit switch 134 can be separate from the baseband control 126, or as part of the baseband control.

From a receive perspective, the radio 120 of FIG. 4 functions much the same way as the radio 20 of FIG. 1. That is, in accordance with a first communication protocol (e.g., in the U.S.), transceivers 122 and 124 function as (or vice versa) main and diversity receive transceivers, respectively. However, in accordance with a second communication protocol (e.g., in Europe), the transceiver 124 functions a receive transceiver and no diversity is provided.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A radio, comprising:
a first transceiver;
a second transceiver; and
a control unit coupled to said first and second transceivers, said control unit selectively implementing one of at least a first and a second communication mode;
wherein, for the first communication mode, said first transceiver transmits and receives data while the second transceiver functions as a diversity receive transceiver, and for the second communication mode, said second transceiver transmits and receives data and does not function as a diversity receive transceiver.

2. The radio of claim 1 further comprising a switch that is selectively controlled to implement at least one of the first and second communication modes.

3. The radio of claim 2 further wherein said control unit comprises a baseband control that is configured to selectively control said switch to implement said at least one of the first and second communication modes.

4. The radio of claim 1 wherein, for the first communication mode, said second transceiver is tuned to a first frequency band, and for the second communication mode, said second transceiver is tuned to a second frequency band that at least partially overlaps with the first frequency band.

5. The radio of claim 1 wherein said control unit receives location information regarding said radio and said control unit selectively implements said one of at least the first and second communication mode based on said location information.

6. The radio of claim 1 wherein said location information is provided by a device selected from a group consisting of a global positioning system (GPS) receiver and a user-input device.

7. An apparatus, comprising:
a radio that comprises a first transceiver, a second transceiver, and a baseband control coupled to said first and second transceivers, said baseband control selectively implementing one of at least a first and a second communication mode;
wherein, for the first communication mode, said first transceiver transmits and receives data while the second transceiver functions as a diversity receive transceiver, and for the second communication mode, said second transceiver transmits and receives data and does not function as a diversity receive transceiver.

8. The apparatus of claim 7 wherein said radio further comprises a switch that is selectively controlled to implement at least one of the first and second communication modes.

9. The apparatus of claim 8 wherein said baseband control is configured to selectively control said switch to implement said at least one of the first and second communication modes.

10. The apparatus of claim 7 wherein, for the first communication mode, said second transceiver is tuned to a first frequency band, and for the second communication mode, said second transceiver is tuned to a second frequency band that at least partially overlaps with the first frequency band.

11. The apparatus of claim 7 further comprising a location information unit that indicates a location of said apparatus, said location used by said baseband control to selectively implement one of at least the first and second communication modes.

12. The apparatus of claim 11 wherein said baseband control selectively implements said at least of the first and second communication modes based on the location.

13. The apparatus of claim 7 wherein said apparatus is a computer.

14. A method, comprising:
determining a location of a radio, said radio comprising first and second transceivers;
if said location comprises a first location, causing said radio to receive via said first and second transceivers with said second transceiver providing diversity; and
if said location comprises a second location, causing said radio to receive via said second transceiver and not said first transceiver.

15. The method of claim 14 wherein an applicable communication protocol in the first location is different from an applicable communication protocol in the second location.

16. The method of claim 14 wherein for the first location, the second transceiver provides diversity in a first frequency band, and for the second location, the second transceiver receives in a second frequency band that at least partially overlaps the first frequency band.
